(19) United States
(12) Patent Application Publication
(10) Pub. No.: US 2013/0227232 A1
(43) Pub. Date: Aug. 29, 2013

(54) PARTITION AWARE QUALITY OF SERVICE FEATURE

(71) Applicant: International Business Machines Corporation, (US)

(72) Inventors: Douglas C. Berg, Rochester, MN (US); Kulvir S. Bhogal, Fort Worth, TX (US); Nitin Gaur, Round Rock, TX (US); Christopher D. Johnson, Rochester, MN (US)

(73) Assignee: International Business Machines Corporation, Armonk, NY (US)

(21) Appl. No.: 13/861,719

(22) Filed: Apr. 12, 2013

Related U.S. Application Data
(63) Continuation of application No. 13/396,910, filed on Feb. 15, 2012.

(51) Int. Cl. G06F 3/06

(52) U.S. Cl. CPC G06F 3/0619
USPC 711/154

(57) ABSTRACT

A method for providing a partition aware quality of service feature may include receiving an indication of data to be stored in a distributed memory grid, determining a quality of service policy rule to be applied in relation to storage of the data in the memory grid based on the indication, and initiating storage of data blocks of the data in the memory grid. The data blocks may be provided with corresponding partition identifiers that facilitate retrieval of the data by indicating a location of storage of respective ones of the data blocks within the memory grid. The method may further include providing a quality of service token in association with the partition identifier based on the quality of service policy rule.

### CROSS-REFERENCE TO RELATED APPLICATIONS

This patent application is a continuation of copending U.S. patent application Ser. No. 13/396,910, filed on Feb. 15, 2012, and entitled “PARTITION AWARE QUALITY OF SERVICE FEATURE,” the entirety of which is hereby incorporated by reference as if set forth verbatim herein and relied upon for all purposes.

### BACKGROUND

Example embodiments generally relate to memory management and, more particularly, relate to a partition aware quality of service (QoS) feature for a memory grid.

### SUMMARY

Some example embodiments may provide an IMDG having a partition aware QoS feature. In this regard, for example, one example embodiment may include a method for providing a partition aware quality of service feature. The method may include receiving an indication of data to be stored in a distributed memory grid, determining a quality of service policy rule to be applied in relation to storage of the data in the memory grid based on the indication, and initiating storage of data blocks of the data in the memory grid. The data blocks may be provided with corresponding partition identifiers that facilitate retrieval of the data by indicating a location of storage of respective ones of the data blocks within the memory grid. The method may further include providing a quality of service token in association with the partition identifier based on the quality of service policy rule.

In another example embodiment, an apparatus for providing a partition aware quality of service feature is provided. The apparatus may include processing circuitry configured to receive an indication of data to be stored in a distributed memory grid, determine a quality of service policy rule to be applied in relation to storage of the data in the memory grid based on the indication, and initiate storage of data blocks of the data in the memory grid. The data blocks may be provided with corresponding partition identifiers that facilitate retrieval of the data by indicating a location of storage of respective ones of the data blocks within the memory grid. The processing circuitry may be further configured to provide a quality of service token in association with the partition identifier based on the quality of service policy rule.

In another example embodiment, a computer program product for providing a partition aware quality of service feature is provided. The computer program product may include a computer-readable storage medium having computer-executable program code instructions stored therein. The computer-executable program code instructions may include program code instructions for receiving an indication of data to be stored in a distributed memory grid, determining a quality of service policy rule to be applied in relation to storage of the data in the memory grid based on the indication, and initiating storage of data blocks of the data in the memory grid. The data blocks may be provided with corresponding partition identifiers that facilitate retrieval of the data by indicating a location of storage of respective ones of the data blocks within the memory grid. The computer program product may further include program code instructions for providing a quality of service token in association with the partition identifier based on the quality of service policy rule.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a functional block diagram of a system for provision of a partition aware QoS feature for an in memory data grid according to an example embodiment;

FIG. 2 illustrates a functional block diagram of an apparatus for provision of a partition aware QoS feature according to an example embodiment;

FIG. 3 is a conceptual block diagram illustrating operation of an apparatus for provision of a partition aware QoS feature according to an example embodiment;

FIG. 4 illustrates a block diagram showing operations associated with a method for providing a partition aware quality of service feature according to an example embodiment; and

FIG. 5 illustrates a block diagram showing a more detailed example of operations associated with a method for providing a partition aware quality of service feature according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

An In Memory Data Grid (IMDG) is a distributed data storage model that employs a plurality of servers that may be geographically collocated or separated. The servers or clusters of servers that are distributed may each form separately partitioned grids. The data is stored in random access memory (RAM) on the servers, and servers can generally be added or removed non-disruptively in order to change the amount of memory space available. The data model of an IMDG is object-based and non-relational. Distributed applications supported by an IMDG are typically written on the .NET or Java application platforms and non-disruptive automated detection and recovery is enabled by the resilient data fabric provided by an IMDG.

IMDGs typically provide faster access to data since using RAM is faster than using disk memory. The data model of an IMDG also provides a data structure in which a key/value store may be employed to provide flexibility for the application developer to link the data model and the application code. The IMDG provides a fault tolerant, highly available, scalable and resilient platform in which hardware and software upgrades can be performed without disruption to operation. The employment of a set of interconnected Java or .NET processes that hold the data in memory may act as a shock absorber to back end databases. Thus, faster data access may be provided with reduced stress on the database.

A client can typically only interact with one grid at a time. Thus, if interaction is required or desired with multiple grids, corresponding individual sessions will typically need to be employed. The grid containers and grid contents of the IMDG are also typically treated equally. Thus, for example, a discriminating level of service is often not able to be provided.

Some example embodiments may provide a QoS type feature for use with an IMDG. Accordingly, some example embodiments may enable the provision of and enforcement of service level agreements (SLA), and/or may provide varying degrees of grid QoS support regarding availability, replication, routing preferences for services based on SLA, cost, and/or the like.

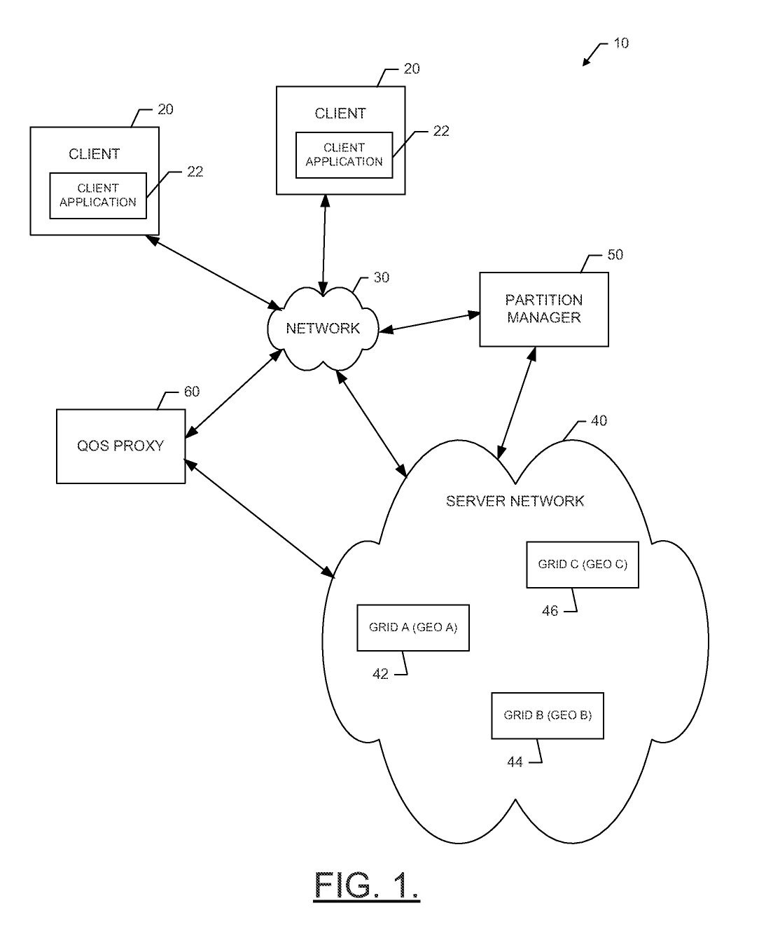

FIG. 1 illustrates an example system in which an embodiment of the present invention may be employed. As shown in FIG. 1, a system 10 according to an example embodiment may include one or more client devices (e.g., clients 20). Notably, although FIG. 1 illustrates two clients 20, it should be appreciated that many more clients 20 may be included in some embodiments and thus, the two clients 20 of FIG. 1 are simply used to illustrate a multiplicity of clients 20 and the number of clients 20 is in no way limiting to other example embodiments. In this regard, example embodiments are scalable to inclusion of any number of clients 20 being tied into the system 10.

The clients 20 may, in some cases, each be computing devices associated with different organizations or the same organization. In some embodiments, each of the clients 20 may be associated with different corresponding locations within a single company. For example, among the clients 20, one client may be associated with a first facility or location of a first organization. Meanwhile, a second client may be associated with a second facility or location of the first organization. In other examples, some of the clients 20 may be associated with the first organization, while other ones of the clients 20 are associated with a second organization.

Each one of the clients 20 may include or otherwise be embodied as a computing device (e.g., a computer, a network access terminal, a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients as described below. In an example embodiment, one or more of the clients 20 may include a client application 22 including software for enabling a respective one of the clients 20 to communicate with the network 30 for requesting and/or receiving information and/or services via the network 30. The information or services receivable at the client applications 22 may include deliverable components (e.g., downloadable software to configure the clients 20, or information for consumption or utilization at the clients 20).

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols. As such, for example, the network 30 may form a cloud computing environment.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of a service. The cloud model may include at least five characteristics, at least three service models and at least four deployment models.

Some of the characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

In an example embodiment, devices to which the clients 20 may be coupled via the network 30 may include a server network 40 including one or more application servers or server clusters of an IMDG. The server network 40 may include a plurality of memory grids that may be geographically collocated or distributed to form the IMDG. Although each of the memory grids may in some cases be referred to as “servers,” this does not necessarily imply that they are embodied on separate servers or devices. As such, for example, a single server or device may include multiple grid locations, or one grid location could constitute a single server or portion thereof. In the example of FIG. 1, three grids are shown (e.g., Grid A 42, Grid B 44 and Grid C 46). However, any number of grids may be provided and thus the illustration of three grids in FIG. 1 is merely to show the potential for multiplicity in the number of grids of the IMDG 40. In this example, each of the grids is geographically distributed. Thus, for example, Grid A 42 is located at geographical location A, Grid B 44 is located at geographical location B, and Grid C 46 is located at geographical location C (e.g., such that each of the grids is located in a different city).

In an example embodiment, data may be stored in IMDG of the server network 40 and may be accessible by the clients 20. Alternatively or additionally, the clients 20 (or other devices) may store data or content in the server network 40 for access and/or use by other clients. When data is to be stored in the IMDG of the server network 40, the data may be chunked into parts. A partition manager 50 may be provided to manage the chunking and distribution of data in the IMDG. In some embodiments, the partition manager 50 may be configured to employ a hash code of a key or value store to determine a partition ID indicative of a location at which a corresponding chunk of data is stored in the IMDG. The partition manager 50 of an example embodiment may also be configured to employ a QoS token in association with the partition ID so that QoS policies may be employed as described herein. Thereafter, routing of requests for data may be handled by a QoS proxy 60 as described in greater detail below. As such, for example, the partition manager 50 may handle the distribution of data in the IMDG, and the QoS proxy 60 may handle the routing of requests and/or the execution of functions that involve access to the distributed data based on knowledge of the schema used to handle the distribution.

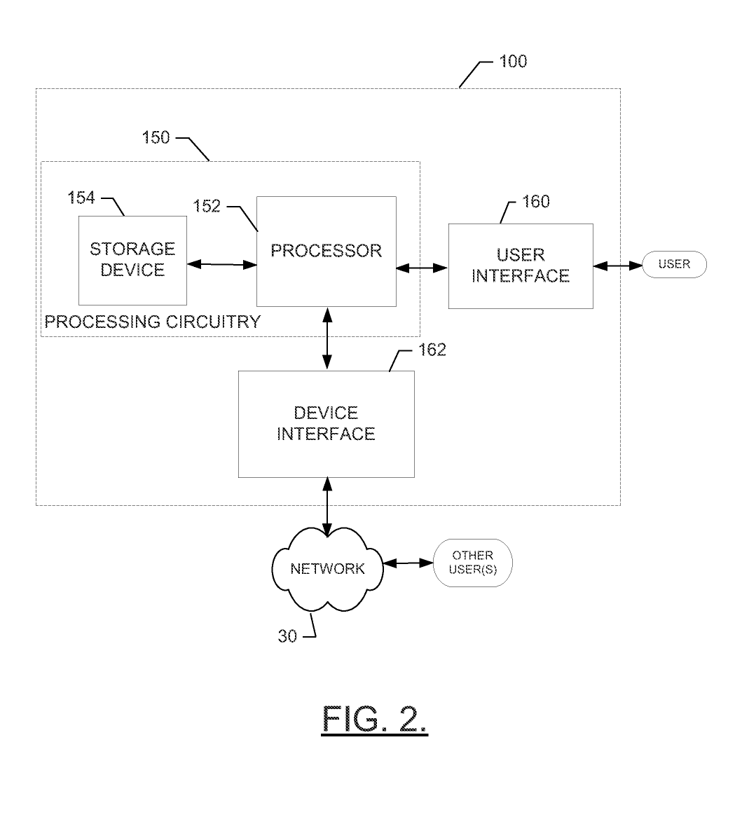

The partition manager 50 and the QoS proxy 60 may each be entities embodied in hardware, software or a combination thereof. An example embodiment of the invention will now be described with reference to FIG. 2. FIG. 2 shows certain elements of an apparatus 100 for provision of a partition aware QoS feature according to an example embodiment. The apparatus of FIG. 2 may be employed, for example, on a computing device (e.g., a computer, network device, server, proxy, or the like). Alternatively, embodiments may be employed on a combination of devices. Accordingly, some embodiments of the present invention may be embodied wholly at a single device (e.g., a server of the server network 40 or another server or computer accessible via the network 30) or by devices having various portions thereof distributed over multiple locations. Furthermore, it should be noted that the devices or elements described below may not be mandatory and thus some may be omitted in certain embodiments.

Referring now to FIG. 2, an apparatus 100 for provision of partition aware QoS feature is provided. The apparatus 100 may be a cloud computing node, in some embodiments. However, since not all embodiments are necessarily practiced in a cloud computing environment, it should be appreciated that the apparatus 100 is not necessarily a cloud computing node in all example embodiments. The apparatus 100 may be an embodiment of the partition manager 50, the QoS proxy 60 or a device hosting either or both of the partition manager 50 and the QoS proxy 60. In some embodiments, the apparatus 100 may be a personal computer system, server computer system, thin client, thick client, handheld or laptop device, multiprocessor system, microprocessor-based system, set top box, programmable consumer electronic device, network PC, minicomputer system, mainframe computer system, distributed cloud computing environment that includes and of the above systems or devices, and/or the like. The apparatus 100 may function, according to its configuration, as any of a number of different entities. As such, configuration of the apparatus 100 as described herein may transform the apparatus 100 into the partition manager 50 or the QoS proxy 60, respectively. In some cases, configuration of the apparatus 100 may be accomplished via executable instructions such as program modules executed by a computer system. The program modules may include routines, programs, objects, components, logic, data structures, and so on that perform particular tasks or implement particular abstract data types.

In an example embodiment, the apparatus 100 may include or otherwise be in communication with processing circuitry 150 that is configured to perform data processing, application execution and other processing and management services according to an example embodiment of the present invention. In one embodiment, the processing circuitry 150 may include a storage device 154 and a processor 152 (which may itself include one or more processors) that may be in communication with or otherwise control a user interface 160 and a device interface 162. As such, the processing circuitry 150 may be embodied as a circuit chip (e.g., an integrated circuit chip) configured (e.g., with hardware, software or a combination of hardware and software) to perform operations described herein. However, in some embodiments, the processing circuitry 150 may be embodied as a portion of a server, computer, laptop, workstation or even one of various mobile computing devices. In situations where the processing circuitry 150 is embodied as a server or at a remotely located computing device, the user interface 160 may be disposed at another device (e.g., at a computer terminal or network access terminal) that may be in communication with the processing circuitry 150 via the device interface 162 and/or a network (e.g., network 30).

Internal communication among components of the apparatus 100 may be accomplished via a communication bus. Such a communication bus may represent one or more of several types of bus structures, including a memory bus or memory controller, a peripheral bus, an accelerated graphics port, and a processor or local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The user interface 160 may be in communication with the processing circuitry 150 to receive an indication of a user input at the user interface 160 and/or to provide an audible, visual, mechanical or other output to the user. As such, the user interface 160 may include, for example, a keyboard, a mouse, a joystick, a display, a touch screen, a microphone, a pointing device, a speaker, or other input/output mechanisms. In embodiments where the apparatus is embodied at a server or other network entity, the user interface 160 may be limited or even eliminated in some cases. Alternatively, as indicated above, the user interface 160 may be remotely located.

The device interface 162 may include one or more interface mechanisms for enabling communication with other devices and/or networks. In some cases, the device interface 162 may be any means such as a device or circuitry embodied in either hardware, software, or a combination of hardware and software that is configured to receive and/or transmit data from/to a network and/or any other device or module in communication with the processing circuitry 150. In this regard, the device interface 162 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 162 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 154 may include one or more non-transitory storage or memory devices such as, for example, volatile and/or non-volatile memory that may be either fixed or removable. As such, the storage device 154 may include random access memory (RAM) and/or cache memory. In some embodiments, the storage device 154 may be a magnetic disk drive or an optical disk drive (e.g., CD ROM, DVD ROM and/or the like). The storage device 154 may be configured to store information, data, applications, program modules, instructions or the like for enabling the apparatus to carry out various functions in accordance with example embodiments of the present invention. For example, the storage device 154 could be configured to buffer input data for processing by the processor 152. Additionally or alternatively, the storage device 154 could be configured to store instructions for execution by the processor 152. As yet another alternative, the storage device 154 may include one of a plurality of databases that may store a variety of files, contents or data sets. Among the contents of the storage device 154, applications may be stored for execution by the processor 152 in order to carry out the functionality associated with each respective application.

The processor 152 may be embodied in a number of different ways. For example, the processor 152 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 152 may be configured to execute instructions stored in the storage device 154 or otherwise accessible to the processor 152. As such, whether configured by hardware or software methods, or by a combination thereof, the processor 152 may represent an entity (e.g., physically embodied in circuitry) capable of performing operations according to embodiments of the present invention while configured accordingly. Thus, for example, when the processor 152 is embodied as an ASIC, FPGA or the like, the processor 152 may be specifically configured hardware for conducting the operations described herein. Alternatively, as another example, when the processor 152 is embodied as an executor of software instructions, the instructions may specifically configure the processor 152 to perform the operations described herein.

In an example embodiment, the processor 152 (or the processing circuitry 150) may be embodied as, include or otherwise control the partition manager 50 or the QoS proxy 60, either of which may be any means such as a device or circuitry operating in accordance with software or otherwise embodied in hardware or a combination of hardware and software (e.g., processor 152 operating under software control, the processor 152 embodied as an ASIC or FPGA specifically configured to perform the operations described herein, or a combination thereof) thereby configuring the device or circuitry to perform the corresponding functions of the partition manager 50 or the QoS proxy 60, respectively, as described below.

In some embodiments, the apparatus 100 may operate based on a set of functional abstraction layers including, for example, a hardware and software layer, a virtualization layer, a management layer and/or a workload layer. In an example embodiment, the hardware and software layer may be provided via a plurality of hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2®, database software. (IBM, zSeries, pSeries, xSeries, BladeCenter, WebSphere, and DB2 are trademarks of International Business Machines Corporation registered in many jurisdictions worldwide). The virtualization layer may provide an abstraction layer from which the following examples of virtual entities may be provided: virtual servers; virtual storage; virtual networks, including virtual private networks; virtual applications and operating systems; and virtual clients. In one example, the management layer may provide any of a number of functions including, for example, resource provisioning metering and pricing, billing or invoicing, security user portal provides access, service level management, Service Level Agreement (SLA) planning and fulfillment, and/or the like. The workloads layer may provide examples of functionality for which the cloud computing environment may be utilized. Examples of workloads and functions which may be provided from this layer include provision of a partition aware QoS feature.

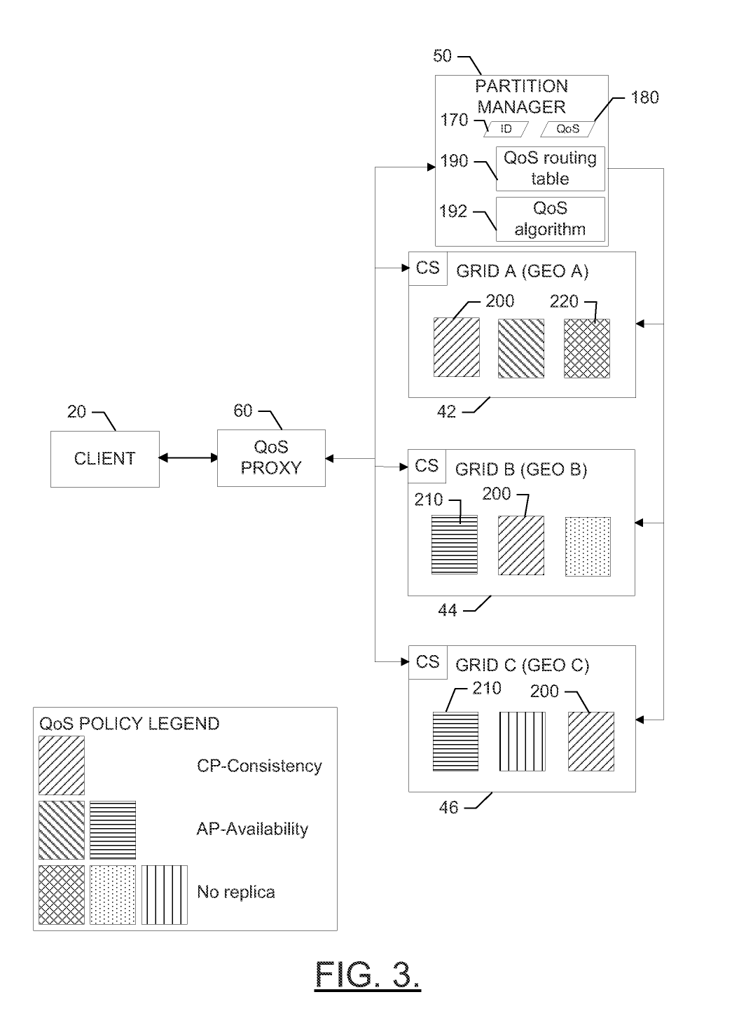

Operation of an example embodiment will now be described in reference to FIG. 3. FIG. 3 is a conceptual block diagram illustrating operation of an example embodiment. As shown in FIG. 3, the partition manager 50 may interact with each of the grids of the IMDG such that, for example, the partition manager 50 is configured to partition data and distribute the data within the grids. In this regard, for example, the partition manager 50 may be configured to use a hash code or value associated with a key used to route chunks of data to a fixed set of partitions (e.g., grid locations). In some embodiments, the partition manager 50 may further act as a QoS manager to define rules or a map to handle grid wide QoS policy enforcement as described herein.

FIG. 3 shows a plurality of data chunks distributed through the grid locations shown in FIG. 1. Upon partitioning the data chunks, the partition manager 50 may further be configured to assign a partition ID 170 to each data chunk to indicate a location of the corresponding partitioned chunk of data and facilitate retrieval of the data. According to an example embodiment, the partition manager 50 may be further configured to provide a QoS token 180 in association with each partition ID 170. The QoS token 180 may be determined based on information regarding the key (e.g., from the key itself or from metadata in the key) that includes information descriptive of the QoS to use (e.g., grid tier). Of note, although FIG. 3 only shows one data chunk having the partition ID 170 and the QoS token 180, it should be appreciated that each of the data chunks shown may employ their own respective partition IDs and QoS tokens, and FIG. 3 only shows one data chunk having these features to simplify the illustration of an example embodiment.

In an example embodiment, the QoS token 180 may be determined by referencing a QoS routing table 190 or by executing a QoS algorithm 192 in association with the key. Thus, for example, the key may be received and the partition manager 50 may lookup the key in QoS routing table 190 to determine a QoS token to be associated with data to be stored in the grid. Alternatively, for example, the key may be received and the partition manager 50 may run a QoS algorithm that is configured to identify the key and employ a set of rules for defining the QoS token to be applied to the data associated with the key. The QoS algorithm 192 may, in some cases, generate a map or object with metadata descriptive of the QoS associated with the data. In embodiments that employ either one (or both) of the QoS routing table 190 or the QoS algorithm 192, the QoS routing table 190 and/or the QoS algorithm 192 may be embodied at the partition manager 50 itself (as shown in the example of FIG. 3), or at some other location accessible to both the partition manager 50 and the QoS proxy 60.

Data stored in the grid may be stored in connection with corresponding QoS policy rules or SLA requirements that are indicative of accessibility parameters that are applicable to the corresponding data, and that are used to generate the QoS routing table 190 and/or guide operation of the QoS algorithm 192. After the data is distributed and stored by the partition manager 50, the client 20 may utilize the QoS proxy 60 to access information stored in the grid. The QoS proxy 60 may be configured to access the QoS routing table 190 or the map generated by the QoS algorithm 192 to have an awareness of the QoS policies associated with data stored in the grid. As such, the QoS proxy 60 may have exposure to the partitioning schema employed by the partition manager 50 including access to and/or knowledge of the QoS token or other indicator associated with various pieces of data.

As such, for example, the partition manager 50 may be configured to include or otherwise access information regarding the keys (e.g., the keys themselves or metadata in the keys) to indicate a QoS policy applied to the corresponding data to be stored. In some embodiments, the partition manager 50 may therefore store data and/or replicate data at different locations within the IMDG in accordance with the QoS policies defined for each respective chunk of data. Thus, for example, the partition manager 50 may be configured to store data with information indicative of a QoS policy to be employed relative to data stored in the IMDG. For example, some data blocks may be stored in connection with a consistency/partition awareness policy (CP) indicating that synchronous replication of such data blocks is required. Meanwhile, other data blocks may be stored in connection with an availability/partition awareness policy (AP) indicating that the data should be replicated eventually and when possible. Other data blocks (e.g., locally applicable data that is not required or desired for replication elsewhere) may be stored in connection with a no replication policy indicating that there is no need for replication of such data in other grid locations. Other policies that may be prescribed by QoS rules may include policies relating to speed of access, performance guarantees (e.g., relating to intra-grid replication), and/or the like. As indicated above, the partition manager 50, or another entity, may act as a QoS manager to act as a placement engine responsible for policy/QoS enforcement. The QoS manager may work with individual catalog servers (CS) of each grid in order to enable replication in each respective grid based on the QoS policy to be applied, as shown in FIG. 3.

As may be appreciated from the example of FIG. 3, CP designated data blocks may represent the most expensive (from a cost or resource consumption perspective) policy and may have the shortest response time. Meanwhile, AP designated data blocks are less expensive and have a longer response time. However, blocks designated for no replication may be the cheapest, but have the longest response time. Data replication may be accomplished across different grid locations based on the QoS token 180 of each data block. Thus, for example, if data block 200, which has a CP QoS token, is initially stored locally at Grid A 42, the data block 200 may be synchronously replicated to Grid B and Grid C at their respective geographic locations. However, data block 210, which has an AP QoS token, may initially be stored locally at Grid C 46. Data block 210 may then be replicated to Grid B 44 as available. Data block 220, which has a no replication QoS token, may initially be locally stored at Grid A 42, and may not be copied at any other grid location.

The QoS proxy 60 may be configured to access the object policy associated with each item stored in order to act as a routing entity with which the client 20 may interact such that the QoS proxy 60 is enabled to enforce policies based on QoS and/or SLA responsive to requests received from the client 20. In this regard, the QoS proxy 60 may include a catalog or placement service an AP/multi-master grid, which is employed to extend the grid from an availability perspective. In some examples, the principles of AP and CP may be amalgamated based on a Cap Theorem or Brewer's CAP Theorem, which provides that in a distributed system it would not be possible to guarantee all three of consistency, availability and partition tolerance, but only two can be guaranteed. Example embodiments may enable the provision of two such guarantees (e.g., CP and AP) in an IMDG by employing QoS policies that enable the system to balance each type of replication and QoS. As such, the QoS proxy 60 provides assistance in relation to policy/SLA redirects.

As an example, if data block 200 is requested by the client 20, and the client is physically located at or closest to geographical location A, the QoS proxy may initially attempt to access the data block 200 from Grid A 42. However, if Grid A 42 is inaccessible for any reason, the QoS proxy 60 may be configured to determine that, based on the QoS policy indicated for data block 200 in the QoS routing table 190, the data block 200 should also be replicated in any of the other grid locations. Thus, the QoS proxy 60 may retrieve the data block 200 from either one of the other grid locations that is closer (or less costly) for the client 20 to access. Meanwhile, if data block 220 is requested, the QoS proxy 60 may be able to determine that the QoS policy for the data block 220 indicates that it is only stored locally at Grid A 42. Thus, if Grid A happens to be inaccessible for any reason, the QoS proxy 60 may be able to inform the client 20 that the data block 220 is inaccessible until the Grid A 42 is restored.

Example embodiments may therefore enable the use of a map or an object with metadata (e.g., the QoS token) that describes the QoS associated with data to be stored in an IMDG. The QoS token may be used to provide varying degrees of grid QoS support such as availability, replication, routing preference, etc. Thus, while static availability, replication and routing mechanisms had previously been the norm, some example embodiments may provide a mechanism by which a discriminating level of service may be provided.

In an example embodiment, the QoS proxy 60 and/or the partition manager 50 may be embodied responsive to loading of process software. Such process software may be loaded into an apparatus (e.g., the apparatus of FIG. 2) by manually loading software directly into a client, server, proxy computer and/or the like via loading from a storage medium such as a CD, DVD, etc. In some embodiments, the process software may alternatively be automatically or semi-automatically deployed into a computer system by sending the process software to a central server or a group of servers. The process software may then be downloaded into a client computer that will execute the process software. Alternatively, the process software may be sent directly to the client system via email. The process software may then either be detached to a directory or loaded into a directory by a button on the email that executes a program that detaches the process software into a directory. Another alternative may be to send the process software directly to a directory on the client computer hard drive. When there are proxy servers, the process may, select the proxy server code, determine on which computers to place the proxy servers' code, transmit the proxy server code, then install the proxy server code on the proxy computer. The process software may be transmitted to the proxy server and then it may be stored on the proxy server.

From a technical perspective, the apparatus 100 described above may be configured accordingly to be used to support some or all of the operations described herein in relation to the QoS proxy 50 and/or the partition manager 50. As such, the platform described in FIG. 2 may be used to facilitate the implementation of several computer program and/or network communication based interactions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

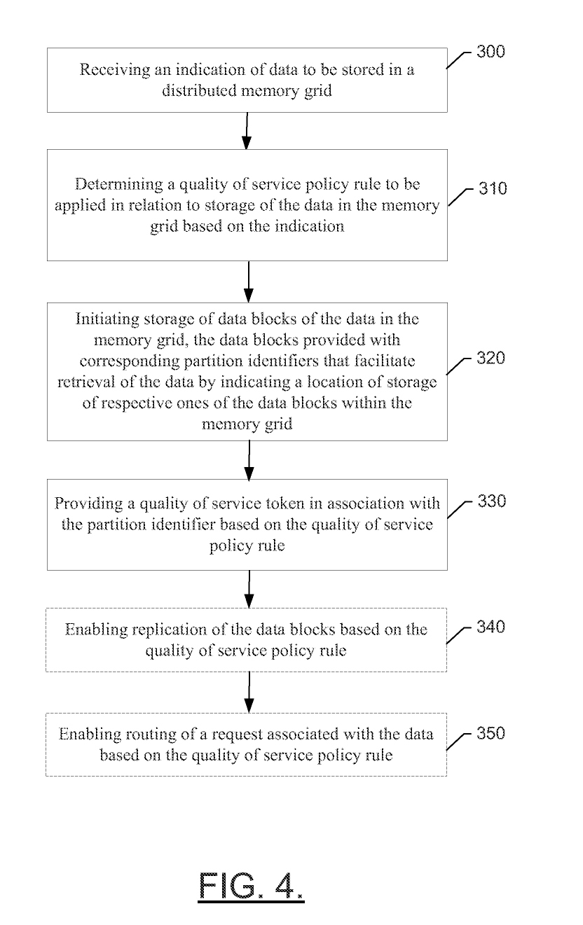

A method according to one embodiment of the invention will now be described in reference to FIG. 4. The method may include receiving an indication of data to be stored in a distributed memory grid at operation 300, determining a quality of service policy rule to be applied in relation to storage of the data in the memory grid based on the indication at operation 310, and initiating storage of data blocks of the data in the memory grid at operation 320. The data blocks may be provided with corresponding partition identifiers that facilitate retrieval of the data by indicating a location of storage of respective ones of the data blocks within the memory grid. The method may further include providing a quality of service token in association with the partition identifier based on the quality of service policy rule at operation 330.

In some embodiments, certain ones of the operations above may be modified or further amplified as described below. Moreover, in some embodiments additional optional operations may also be included (some examples of which are shown in dashed lines in FIG. 4). It should be appreciated that each of the modifications, optional additions or amplifications below may be included with the operations above either alone or in combination with any others among the features described herein. In this regard, in some embodiments the method may further include enabling replication of the data blocks based on the quality of service policy rule at operation 340 and/or enabling routing of a request associated with the data based on the quality of service policy rule at operation 350. In an example embodiment, determining the quality of service policy rule may include referencing a routing table associating the indication with a corresponding policy rule or associating metadata associated with the indication with a corresponding policy rule. Alternatively or additionally, determining the quality of service policy rule may include utilizing an assignment algorithm generating the quality of service policy rule based on the indication or based on metadata associated with the indication. In some embodiments, determining the quality of service policy rule may include determining a policy associating the data block with a corresponding policy relative to at least one of availability, consistency, speed of access, or a performance guarantee.

In an example embodiment, an apparatus for performing the method of FIG. 4 above may comprise a processor (e.g., the processor 152) configured to perform some or each of the operations (300-350) described above. The processor may, for example, be configured to perform the operations (300-350) by performing hardware implemented logical functions, executing stored instructions, or executing algorithms for performing each of the operations.

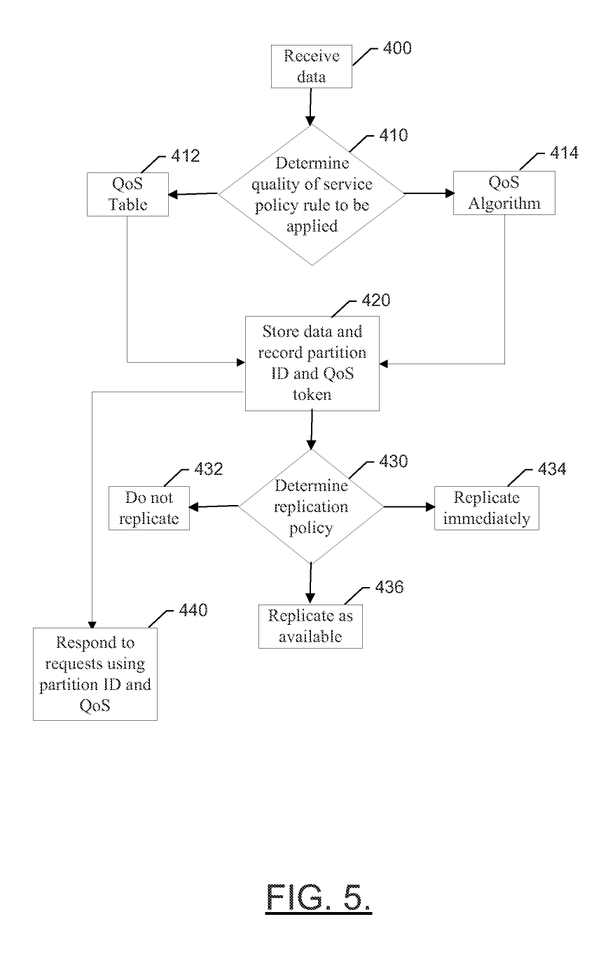

FIG. 5 illustrates a block diagram showing a more detailed example of operations associated with a method for providing a partition aware quality of service feature according to an example embodiment. In this regard, for example, the method may be performed by the apparatus 100 of FIG. 2 (e.g., acting as the partition manager and/or QoS manager). Data is received at operation 400 and a determination is made as to the quality of service policy rule to be applied at operation 410. The determination may be made either by referencing a QoS table at operation 412 or by applying a QoS algorithm at operation 414. Thereafter, data may be stored and the partition ID for the storage location may be recorded along with a QoS token at operation 420. A determination may then be made regarding replication of the data in other grid locations at operation 430. If a no replication policy is in effect for the data, then the data will not be replicated at operation 432. If a consistency policy is defined for the data, then the data will be replicated in other grids immediately at operation 434. If an availability policy is defined for the data, then the data will be replicated to other grids as resources become available at operation 436. The partition ID and QoS token may then be utilized for responding to requests for data at operation 440.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A method comprising:
receiving an indication of data to be stored in a distributed memory grid;
determining a quality of service policy rule to be applied in relation to storage of the data in the memory grid based on the indication;
initiating storage of data blocks of the data in the memory grid, the data blocks provided with corresponding partition identifiers that facilitate retrieval of the data by indicating a location of storage of respective ones of the data blocks within the memory grid; and
providing a quality of service token in association with the partition identifier based on the quality of service policy rule.

2. The method of claim 1, wherein determining the quality of service policy rule comprises referencing a routing table associating the indication with a corresponding policy rule.

3. The method of claim 1, wherein determining the quality of service policy rule comprises referencing a routing table associating metadata associated with the indication with a corresponding policy rule.

4. The method of claim 1, wherein determining the quality of service policy rule comprises utilizing an assignment algorithm generating the quality of service policy rule based on the indication.

5. The method of claim 1, wherein determining the quality of service policy rule comprises utilizing an assignment algorithm generating the quality of service policy rule based on metadata associated with the indication.

6. The method of claim 1, further comprising enabling replication of the data blocks based on the quality of service policy rule.

7. The method of claim 1, wherein determining the quality of service policy rule comprises determining at least one of availability, consistency, speed of access, and a performance guarantee.

8. The method of claim 1, further comprising enabling routing of a request associated with the data based on the quality of service policy rule.
